(19) United States
(12) Patent Application Publication
(10) Pub. No.: US 2024/0051589 A1
(43) Pub. Date: Feb. 15, 2024

(54) RETRACTABLE FOLDING TROLLEY

(71) Applicant: Yongshuai Zhou, Jinhua City (CN)

(72) Inventors: Yongshuai Zhou, Jinhua City (CN); Guosen Zou, Jinhua City (CN)

(73) Assignee: Yongshuai Zhou, Jinhua City (CN)

(21) Appl. No.: 18/447,967

(22) Filed: Aug. 10, 2023

(30) Foreign Application Priority Data
Aug. 12, 2022 (CN) 202222126101.6

(51) Int. Cl. B62B 3/02; B62B 5/04

(52) U.S. Cl. CPC B62B 3/02; B62B 5/0438; B62B 5/0461; B62B 3/002

(57) ABSTRACT

The present disclosure provides a retractable folding trolley, including a frame and a storage bag detachably mounted on the frame. The frame includes a support rod, a first retractable rod crosswise arranged around the frame, and a second retractable rod crosswise arranged at the bottom of the frame. A first connecting seat is mounted at the bottom of the support rod, a second connecting seat is slidably mounted on the support rod, a third connecting seat and a locking seat are arranged at the bottom of the frame, and one end of the second retractable rod is hinged to the locking seat. The overall size and height of the folding trolley of the present disclosure after retraction are smaller than those of a conventional folding trolley, which is convenient for storage and carrying.

### CROSS-REFERENCE TO RELATED PATENT APPLICATIONS

This application claims priority to and the benefit of Chinese Patent Application No. 202222126101.6, filed Aug. 12, 2022, the entire disclosure of which, including the specification, drawings, claims, and abstract, is incorporated herein by reference in its entirety.

### TECHNICAL FIELD

The present disclosure relates to the technical field of folding trolleys, and in particular to a retractable folding trolley.

### BACKGROUND

With the improvement of living standards, more and more people like to drive for outdoor activities. Moreover, they will carry a lot of picnic food and outdoor utensils when driving. However, they can only drive to the parking place, and the remaining distance usually needs to be done on foot. Therefore, it is very inconvenient for people to carry so many things outdoors. Now trolleys that can be folded and placed in the trunk are available on the market. When used, the trolley can be opened for carrying picnic food and outdoor utensils, which is convenient for people to carry.

The existing trolleys are mainly translational folding trolleys, which are formed by cross-hinging of steel tubes to form a set of X-shaped cross-tubes that can be folded and retracted. Although this structure is simple, the trolley of such structure has a relatively long length after folding and contraction, and still occupies more space when stored, which is inconvenient to carry. The side support strength of the trolley of such structure is relatively weak, resulting in limited load capacity and short service life. The existing folding trolleys are single-function and not easy to use outside.

### SUMMARY

### (1) Technical Problem to be Solved

The problem to be solved by the present disclosure is to provide a retractable folding trolley to overcome the defect of a large occupied space after the folding trolley retracts in the prior art.

### (2) Technical Solution

To solve the technical problem, the present disclosure provides a retractable folding trolley, including a frame and a storage bag detachably mounted on the frame. The frame includes a support rod, a first retractable rod crosswise arranged around the frame, and a second retractable rod crosswise arranged at the bottom of the frame. A first connecting seat is mounted at the bottom of the support rod. A second connecting seat is slidably mounted on the support rod. The first retractable rods located at two ends are hinged to the first connecting seat and the second connecting seat respectively. A third connecting seat and a locking seat are arranged at the bottom of the frame. One end of the second retractable rod is hinged to the locking seat. The third connecting seat is used for connecting the first retractable rod and the second retractable rod and one ends of the second retractable rod located at the corners are all hinged to the first connecting seat. When retracting, the locking seat is lifted up, the second retractable rod contracts upwards while driving the third connecting seat to collapse inwards, so that the second connecting seat slides upwards along the support rod and the first retractable rods collapse to each other.

Further, a mounting seat is arranged on the upper end of the support rod, a mounting frame is fixed to the mounting seat, and the corner of the storage bag is detachably mounted on the mounting frame; the mounting seat is detachably mounted on the support rod, a locking member is hinged to the support rod, the locking member is movably arranged in the mounting seat, a spring is arranged in the locking member, one end of the spring abuts against the mounting seat, a pressing portion and a clamp hook are arranged on the locking member, the clamp hook abuts against the mounting seat, and the pressing portion is arranged outside the mounting seat. After the pressing portion is pressed, the spring retracts, and the hook is separated from the mounting seat. At this time, the mounting seat can be disassembled. When the spring is reset, the pressing portion can be driven to pop up, and then the clamp hook abuts against the mounting seat again.

Further, a hanging groove is symmetrically arranged on the mounting frame, a hook is symmetrically arranged at the corner of the storage bag, and a bent flap is arranged on one side of the storage bag.

Further, the locking seats are arranged in the middle of the bottom of the frame, and the third connecting seat is symmetrically arranged on both sides of the bottom of the frame. The locking seat is X-shaped, four slots are crosswise arranged on the locking seat, and the second retractable rod is hinged to the slot. The locking seat can prevent mutual retraction between the second retractable rods from both sides to the inside to achieve a locking action.

Further, a first connecting portion, a second connecting portion and a third connecting portion are arranged on the third connecting seat, the second retractable rods are hinged to the first connecting portion and the second connecting portion respectively, and the first retractable rod is hinged to the third connecting portion.

Further, three hinge grooves are arranged on the first connecting seat, an end of the second retractable rod is hinged to the middle hinge groove, and the first retractable rods are hinged to the hinge grooves on both sides respectively.

Further, the upper ends of the first retractable rods located at the corners are hinged to the second connecting seat respectively, a bracket is mounted on the support rod at the front end and a handle is hinged between the brackets through a swing rod.

Further, a roller is mounted at the bottom of the support rod, a hand brake is arranged on one side of the roller, a plurality of tooth portions are arranged on the roller, and a locking portion is arranged on the hand brake corresponding to the tooth portion.

### (3) Beneficial Effect

According to the retractable folding trolley of the present disclosure, with the bottom locking seat, both sides of the frame can be locked, so that the frame will not retract automatically when force is applied to both sides. When the locking seat is moved to the top, the second connecting seat around can be driven to rise along the support rod, and then the first retractable rods on both sides can be driven to realize the frame retraction. The overall size and height of the folding trolley after retraction are smaller than those of a conventional folding trolley, which is convenient for storage and carrying.

### BRIEF DESCRIPTION OF THE DRAWINGS

FIG. 1 is a three-dimensional diagram of a retractable folding trolley according to the present disclosure.

FIG. 2 is a three-dimensional diagram of a frame of the retractable folding trolley according to the present disclosure.

FIG. 3 is an enlarged view of portion A in FIG. 2 of the retractable folding trolley according to the present disclosure.

FIG. 4 is a three-dimensional diagram of the bottom of the frame of the retractable folding trolley according to the present disclosure.

FIG. 5 is a three-dimensional diagram of the side end of the frame of the retractable folding trolley according to the present disclosure.

FIG. 6 is a three-dimensional diagram of the storage state of the frame of the retractable folding trolley according to the present disclosure.

FIG. 7 is a three-dimensional diagram of a mounting seat and a mounting frame of the retractable folding trolley according to the present disclosure.

FIG. 8 is a cross-sectional view of the mounting seat and a locking member of the retractable folding trolley according to the present disclosure.

FIG. 9 is a three-dimensional diagram of a wheel of the retractable folding trolley according to the present disclosure.

FIG. 10 is a three-dimensional diagram of a storage bag of the retractable folding trolley according to the present disclosure.

List of numerals: 1, storage bag; 2, support rod; 3, first retractable rod; 4, second retractable rod; 5, flap; 6, first connecting seat; 7, second connecting seat; 8, third connecting seat; 9, locking seat; 10, mounting seat; 11, mounting frame; 12, locking member; 13, spring; 14, clamp hook; 15, hanging groove; 16, hook; 17, slot; 18, first connecting portion; 19, second connecting portion; 20, third connecting portion; 21, hinge groove; 22, bracket; 23, swing rod; 24, handle; 25, roller; 26, hand brake; 27, tooth portion; 28, locking portion; and 29, pressing portion.

### DETAILED DESCRIPTION

The specific implementations of the present disclosure are described in further detail below in combination with the accompanying drawings and embodiments. The following embodiments are used for illustrating the present disclosure, but are not intended to limit the scope of the present disclosure.

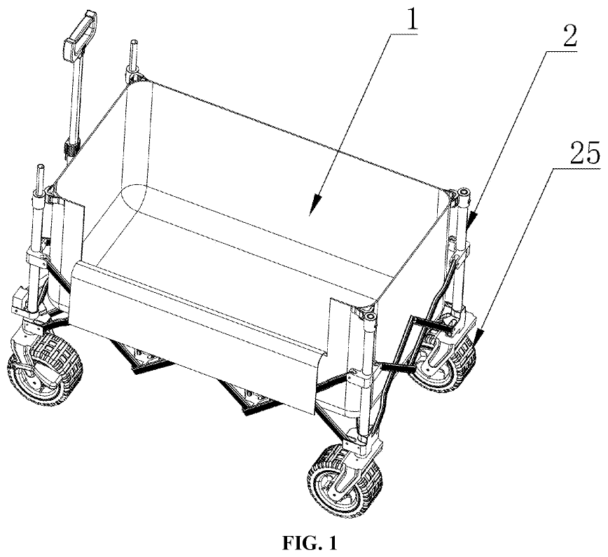

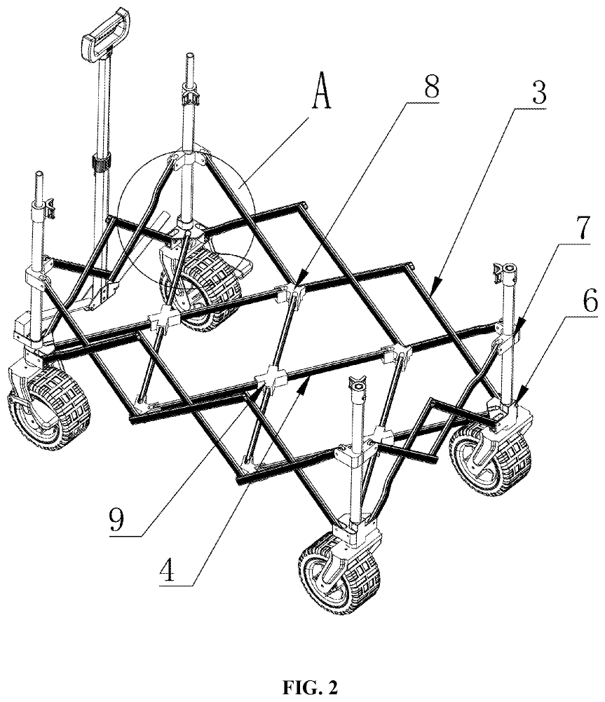

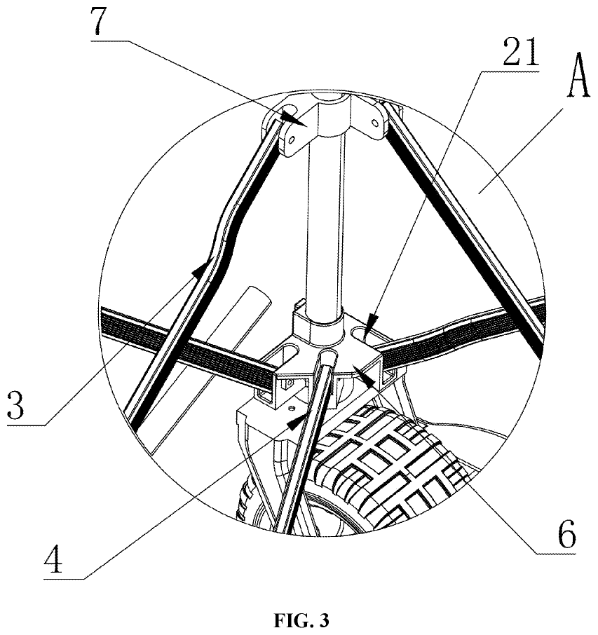

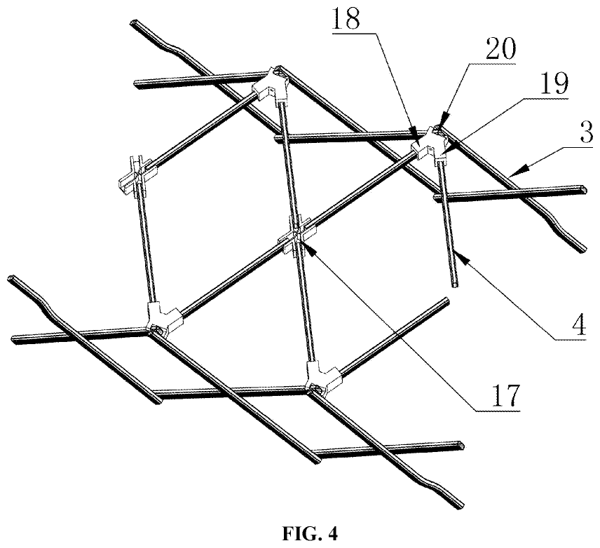

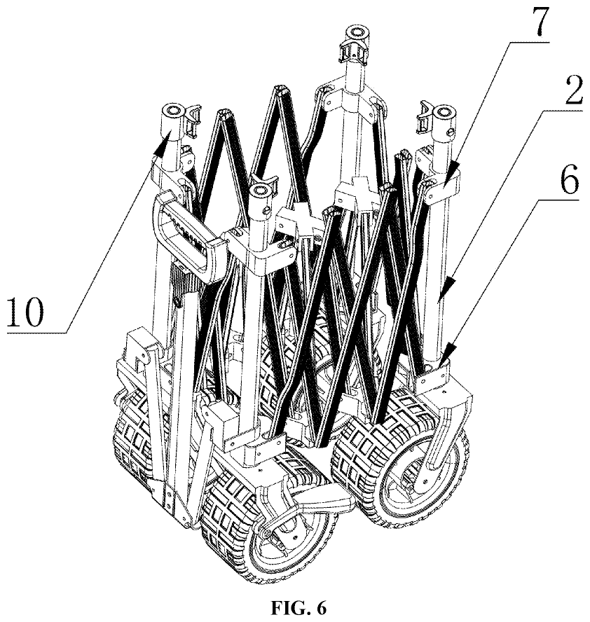

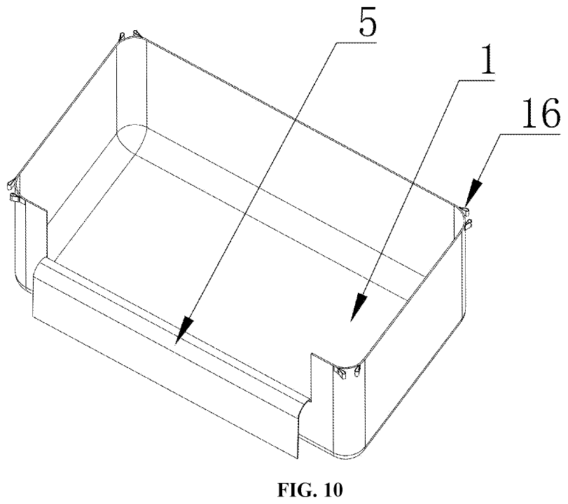

Referring to FIG. 1 to FIG. 10, the present disclosure provides a retractable folding trolley, including a frame and a storage bag 1 detachably mounted on the frame. A bent flap 5 is arranged on one side of the storage bag 1. The frame includes a support rod 2, a first retractable rod 3 crosswise arranged around the frame, and a second retractable rod 4 crosswise arranged at the bottom of the frame. A first connecting seat 6 is mounted at the bottom of the support rod 2. A second connecting seat 7 is slidably mounted on the support rod 2. The first retractable rods 3 located at two ends are hinged to the first connecting seat 6 and the second connecting seat 7 respectively. A third connecting seat 8 and a locking seat 9 are arranged at the bottom of the frame. One end of the second retractable rod 4 is hinged to the locking seat 9. The third connecting seat 8 is used for connecting the first retractable rod 3 and the second retractable rod 4 and one ends of the second retractable rods 4 located at the corners are all hinged to the first connecting seat 6. Specifically, the locking seats 9 are arranged in the middle of the bottom of the frame, and the third connecting seat 8 is symmetrically arranged on both sides of the bottom of the frame. The locking seat 9 is X-shaped, four slots 17 are crosswise arranged on the locking seat 9, and the second retractable rod 4 is hinged to the slot 17. Through the slot 17, the motion trajectory of the second retractable rod 4 can be limited, so that the frame cannot retract from both sides to move inward, and the second retractable rod 4 at the bottom can only rise to achieve a locking action.

A first connecting portion 18, a second connecting portion 19 and a third connecting portion 20 are arranged on the third connecting seat 8. The second retractable rods 4 are hinged to the first connecting portion 18 and the second connecting portion 19 respectively. The first retractable rod 3 is hinged to the third connecting portion 20. Three hinge grooves 21 are arranged on the first connecting seat 6. An end of the second retractable rod 4 is hinged to the middle hinge groove 21. The first retractable rods 3 are hinged to the hinge grooves 21 on both sides respectively. The upper ends of the first retractable rods 3 located at the corners are hinged to the second connecting seat 7 respectively. When retracting, the locking seat 9 is lifted up, the second retractable rod 4 retracts upwards while driving the third connecting seat 8 to collapse inwards, so that the second connecting seat 7 slides upwards along the supporting rod 2 and the first retractable rods 3 collapse to each other.

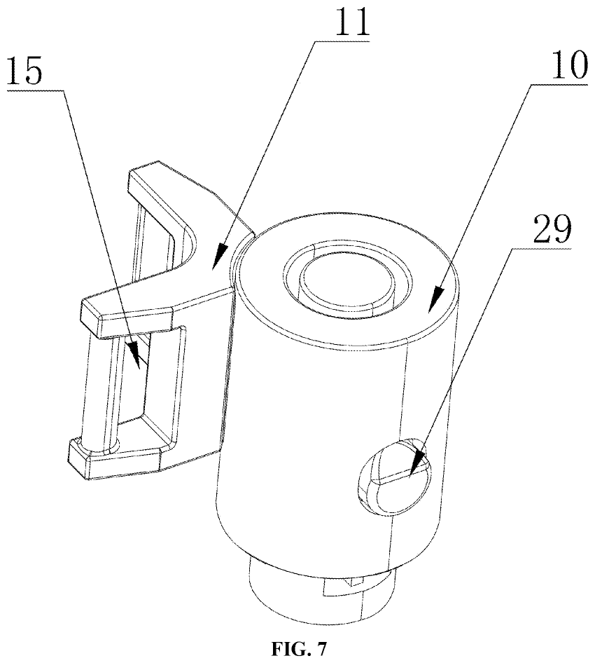

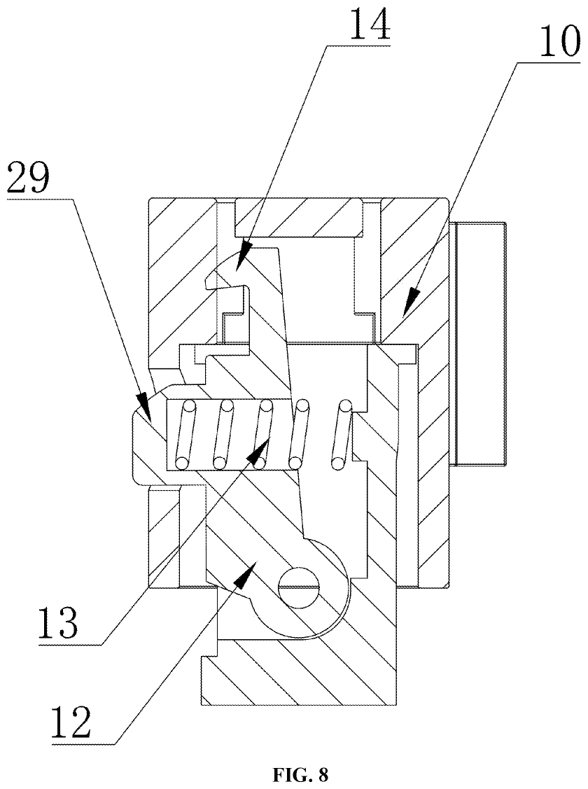

Referring to FIG. 7 and FIG. 8, in this embodiment, a mounting seat 10 is arranged on the upper end of the support rod 2. A mounting frame 11 is fixed to the mounting seat 10. The corner of the storage bag 1 is detachably mounted on the mounting frame 11. Specifically, the mounting seat 10 is detachably mounted on the support rod 2, a locking member 12 is hinged to the support rod 2, and the locking member 12 is movably arranged in the mounting seat 10. A spring 13 is arranged in the locking member 12. One end of the spring 13 abuts against the mounting seat 10. A pressing portion 29 and a clamp hook 14 are arranged on the locking member 12. The clamp hook 14 abuts against the mounting seat 10. The pressing portion 29 is arranged outside the mounting seat 10. After the pressing portion 29 is pressed, the spring 13 retracts. At this time, the hook 14 is separated from the mounting seat 10 after the locking member 12 swings, and the mounting seat 10 can be disassembled. After assembling, the spring 13 ejects the pressing portion 29 to make the locking member 12 swing, and the clamp hook 14 abuts against the mounting seat 10. At this time, the mounting seat 10 is locked. In this embodiment, a hanging groove 15 is symmetrically arranged on the mounting frame 11, and a hook 16 is symmetrically arranged at the corner of the storage bag 1. Under the cooperation of the hook 16 and the hanging groove 15, the storage bag 1 is detachably mounted.

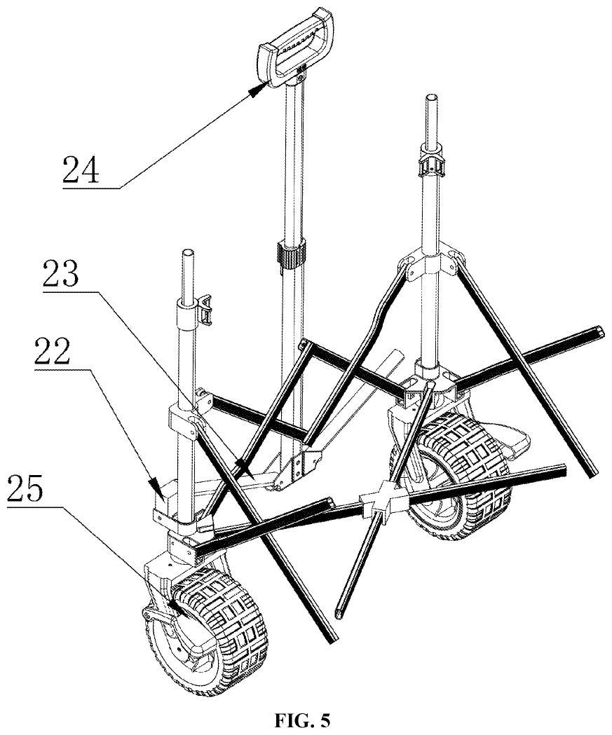

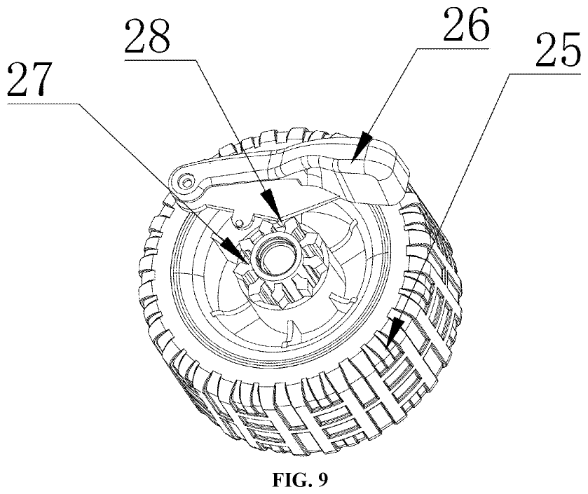

Referring to FIG. 5 and FIG. 9, in this embodiment, a bracket 22 is mounted on the support rod 2 at the front end and a handle 24 is hinged between the brackets 22 through a swing rod 23. A roller 25 is mounted at the bottom of the support rod 2. A hand brake 26 is arranged on one side of the roller 25. A plurality of tooth portions 27 are arranged on the roller 25, and a locking portion 28 is arranged on the hand brake 26 corresponding to the tooth portion 27. The hand brake 26 is operated to make the locking portion 28 insert into the tooth portion 27. At this time, the roller 25 is locked.

According to the retractable folding trolley of the present disclosure, with the bottom locking seat, both sides of the frame can be locked, so that the frame will not retract automatically when force is applied to both sides. When the locking seat is moved to the top, the second connecting seat around can be driven to rise along the support rod, and then the first retractable rods on both sides can be driven to realize the frame retraction. The overall size and height of the folding trolley after retraction are smaller than those of a conventional folding trolley, which is convenient for storage and carrying.

The above is only preferred implementation of the present disclosure, and it should be noted that, for a person of ordinary skill in the art, some improvements and embellishments can be made without departing from the technical principle of the present disclosure, and these improvements and embellishments should also be regarded as the scope of protection of the present disclosure.

What is claimed is:

1. A retractable folding trolley, comprising a frame and a storage bag detachably mounted on the frame, wherein the frame comprises a support rod, a first retractable rod crosswise arranged around the frame, and a second retractable rod crosswise arranged at the bottom of the frame, a first connecting seat is mounted at the bottom of the support rod, a second connecting seat is slidably mounted on the support rod, the first retractable rods located at two ends are hinged to the first connecting seat and the second connecting seat respectively, a third connecting seat and a locking seat are arranged at the bottom of the frame, one end of the second retractable rod is hinged to the locking seat, the third connecting seat is used for connecting the first retractable rod and the second retractable rod and one ends of the second retractable rod located at the corners are all hinged to the first connecting seat; and when retracting, the locking seat is lifted up, the second retractable rod retracts upwards while driving the third connecting seat is driven to collapse inwards, so that the second connecting seat slides upwards along the support rod and the first retractable rods collapse to each other.

2. The retractable folding trolley according to claim 1, wherein a mounting seat is arranged on the upper end of the support rod, a mounting frame is fixed to the mounting seat, and the corner of the storage bag is detachably mounted on the mounting frame.

3. The retractable folding trolley according to claim 2, wherein the mounting seat is detachably mounted on the support rod, a locking member is hinged to the support rod, the locking member is movably arranged in the mounting seat, a spring is arranged in the locking member, one end of the spring abuts against the mounting seat, a pressing portion and a clamp hook are arranged on the locking member, the clamp hook abuts against the mounting seat, and the pressing portion is arranged outside the mounting seat.

4. The retractable folding trolley according to claim 2, wherein a hanging groove is symmetrically arranged on the mounting frame, and a hook is symmetrically arranged at the corner of the storage bag.

5. The retractable folding trolley according to claim 1, wherein the locking seats are arranged in the middle of the bottom of the frame, and the third connecting seat is symmetrically arranged on both sides of the bottom of the frame.

6. The retractable folding trolley according to claim 1, wherein the locking seat is X-shaped, four slots are crosswise arranged on the locking seat (9), and the second retractable rod is hinged to the slot.

7. The retractable folding trolley according to claim 1, wherein a first connecting portion, a second connecting portion and a third connecting portion are arranged on the third connecting seat, the second retractable rods are hinged to the first connecting portion and the second connecting portion respectively, and the first retractable rod is hinged to the third connecting portion.

8. The retractable folding trolley according to claim 1, wherein three hinge grooves are arranged on the first connecting seat, an end of the second retractable rod is hinged to the middle hinge groove, and the first retractable rods are hinged to the hinge grooves on both sides respectively.

9. The retractable folding trolley according to claim 1, wherein the upper ends of the first retractable rods located at the corners are hinged to the second connecting seat respectively.

10. The retractable folding trolley according to claim 1, wherein a bracket is mounted on the support rod at the front end and a handle is hinged between the brackets through a swing rod.

11. The retractable folding trolley according to claim 1, wherein a roller is mounted at the bottom of the support rod.

12. The retractable folding trolley according to claim 11, wherein a hand brake is arranged on one side of the roller, a plurality of tooth portions are arranged on the roller, and a locking portion is arranged on the hand brake corresponding to the tooth portion.

13. The retractable folding trolley according to claim 1, wherein a bent flap is arranged on one side of the storage bag.
